(19) United States
(12) Patent Application Publication
(10) Pub. No.: US 2018/0114236 A1
(43) Pub. Date: Apr. 26, 2018

(54) Method for Predicting a Demand for Vehicles for Hire

(71) Applicant: MASTERCARD ASIA/PACIFIC PTE. LTD., SINGAPORE (SG)

(72) Inventors: Edwin L. Pelikan, Lake St. Louis, MO (US); Milankumar Desai, Singapore (SG)

(21) Appl. No.: 15/789,699

(22) Filed: Oct. 20, 2017

(30) Foreign Application Priority Data
Oct. 21, 2016 (SG) 10201608855S

(51) Int. Cl. G06Q 30/02

(52) U.S. Cl. CPC G06Q 30/0202

(57) ABSTRACT

A computer-implemented method for predicting a demand for vehicles for hire in one or more locations, the method comprising the steps of: obtaining, by a server, financial transaction data for a plurality of financial transactions from one or more merchants, the financial transaction data comprising location information for each financial transaction, the location information corresponding to the one or more locations; determining, by the server, a departure rate in the one or more locations based on a number of the financial transactions occurring over a predefined period; and estimating, by the server, the demand for vehicles for hire in the one or more locations based on the departure rate.

### CROSS-REFERENCE TO RELATED APPLICATION

This application claims the benefit of and priority to Singapore Patent Application No. 10201608855S filed Oct. 21, 2016. The entire disclosure of the above application is incorporated herein by reference.

### FIELD

The present disclosure relates broadly, but not exclusively, to methods for predicting a demand for vehicles for hire.

### BACKGROUND

This section provides background information related to the present disclosure which is not necessarily prior art.

Vehicles for hire provide services for transporting passengers from a departing point to a destination of their choice. Taxicabs and motorcycle taxis are two common types of vehicles for hire. The demand for this mode of transportation (i.e. “on-demand” transportation) has led some technology companies, such as Uber® and Grab®, to develop mobile applications for online booking of vehicles for hire.

Conventionally, drivers of on-demand transportation would drive around to locate passengers or stay idle at a place to wait for passengers. The drivers could also pick up passengers who make requests for their services through phone calls or mobile applications at a specific place.

Without the knowledge of the demand in different locations at any given time, there may be an oversupply of vehicles for hire at places where there is no commensurate demand and vice versa. This is undesirable for both the drivers and passengers as there is a shortage of work where there is driver oversupply, and a shortage of supply where there is passenger oversupply.

It would be useful to provide a method for predicting a demand for vehicles for hire.

### SUMMARY

This section provides a general summary of the disclosure, and is not a comprehensive disclosure of its full scope or all of its features. Aspects and embodiments of the disclosure are set out in the accompanying claims.

According to a first aspect of the present disclosure, there is provided a computer-implemented method for predicting a demand for vehicles for hire in one or more locations, the method comprising the steps of: obtaining, by a server, financial transaction data for a plurality of financial transactions from one or more merchants, the financial transaction data comprising location information for each financial transaction, the location information corresponding to the one or more locations; determining, by the server, a departure rate in the one or more locations based on a number of the financial transactions occurring over a predefined period; and estimating, by the server, the demand for vehicles for hire in the one or more locations based on the departure rate.

The step of obtaining financial transaction data may comprise the steps of: obtaining, by the server, merchant identification information for each financial transaction to identify the respective merchant, of the one or more merchants, for the respective financial transaction; and obtaining, from a merchant database, the location information of the respective financial transaction based on the merchant identification information.

The merchant identification information may comprise at least one selected from a group consisting of a merchant name and a merchant code.

The step of obtaining financial transaction data may comprise the steps of: obtaining, by the server, customer identification information for each financial transaction to identify the respective customer for the financial transaction; obtaining, from a customer database and based on the customer identification information, historical financial transaction data for historical financial transactions made by the respective customer in transportation activity; and determining, by the server, preference in transportation activity of the respective customer based on the historical financial transaction data for historical financial transactions in transportation activity.

The step of analysing the financial transaction data may comprise the steps of: assigning a weight to one or more financial transactions based on the determined preference in transportation activity of the respective customer; and determining the departure rate in the one or more locations based on the one or more weighted financial transactions.

The financial transaction data may further comprise at least one external data set, the external data set being stored in one or more external databases.

The at least one external data set may comprise information with respect to real-time events occurring in the one or more locations.

The information may comprise at least one selected from a group consisting of weather information, sporting event information, transaction density information and airline flight data.

The method may further comprise the step of: calculating a location score for the one or more locations based on the estimated demand and a characteristic of the respective location, the location scoring being indicative of a potential passenger density at the respective location.

The location score is calculated for two or more locations, the method may further comprise the step of: creating a heat map showing the location scores for the two or more locations.

According to a second aspect of the present disclosure, there is provided a computer-implemented method for assigning vehicles for hire to one or more locations, the method comprising the steps of: predicting a demand for vehicles at the one or more locations according to the method as defined in the first aspect; and assigning, by the server, vehicles for hire to the one or more locations based on the demand.

According to a third aspect of the present disclosure, there is a computer system for predicting a demand for vehicles for hire in one or more locations, the computer system comprising: a memory device for storing data; a display; and a processor coupled to the memory device and being configured to: obtain financial transaction data for a plurality of financial transactions from one or more merchants, the financial transaction data comprising location information for each financial transaction; determine a departure rate in the one or more locations based on a number of the financial transactions occurring over a predefined period; and estimate the demand for vehicles for hire in the one or more locations based on the departure rate.

According to a fourth aspect of the present disclosure, there is a computer program embodied on a non-transitory computer readable medium for predicting a demand for vehicles for hire in one or more locations, the program comprising at least one code segment executable by a computer to instruct the computer to: obtain, by a processor, financial transaction data for a plurality of financial transactions from one or more merchants, the financial transaction data comprising location information for each financial transaction; determine, by the processor, a departure rate in the one or more locations based on a number of the financial transactions occurring over a predefined period; and estimate, by the processor, the demand for vehicles for hire in the one or more locations based on the departure rate.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Embodiments of the disclosure will be better understood and readily apparent to one of ordinary skill in the art from the following written description and the drawings, in which:

FIG. 1 shows a flow chart illustrating a computer-implemented method for predicting a demand for vehicles for hire in one or more locations according to an example embodiment.

FIG. 2 shows a detailed workflow illustrating a computer-implemented method for predicting a demand for vehicles for hire in one or more locations, according to an example embodiment.

FIG. 3 shows a schematic diagram illustrating a computer suitable for implementing the method and system of the example embodiments.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure. Again, like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “obtaining”, “estimating”, “assigning”, “creating”, “predicting”, “capturing”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer, or other device, selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium such as exemplified in the GSM mobile telephone system. The computer program, when loaded and executed on such a computer, effectively results in an apparatus that implements the steps of the preferred method.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers.

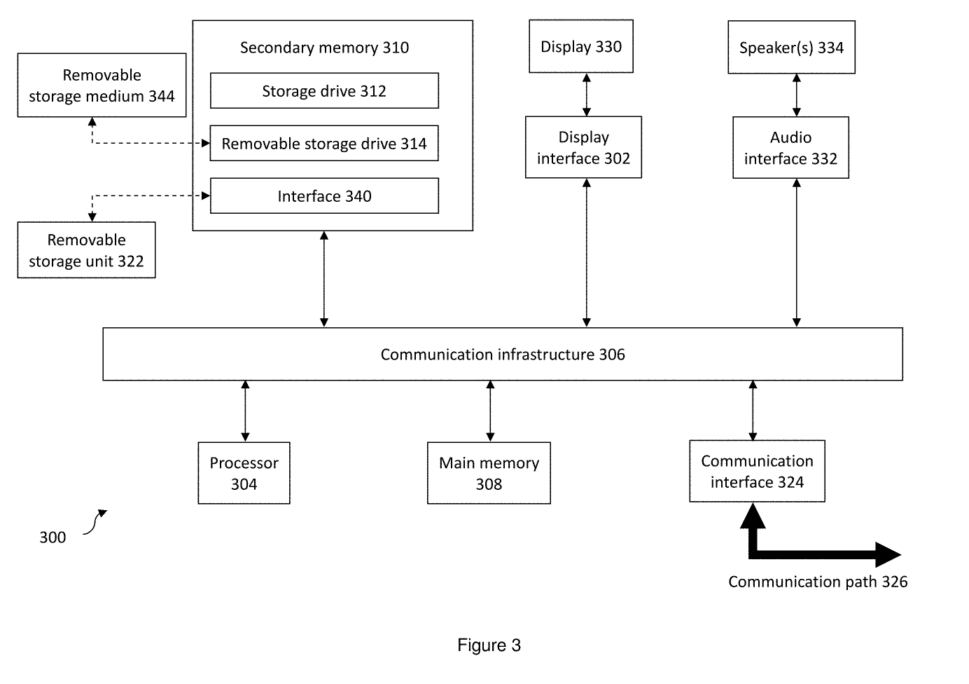

As used herein, the terms “module” and “database” refer to a single computing device or a plurality of interconnected computing devices which operate together to perform a particular function. That is, the “module” and “database” may be contained within a single hardware unit or be distributed among several or many different hardware units. An exemplary computing device which may be operated as a “module” and “database” is described below with reference to FIG. 3.

Many merchants accept electronic payment transactions as an alternative to cash for payment for goods and/or services (collectively referred to as “products”). In such electronic payment transactions, a payment vehicle, e.g., a payment card, such as a credit or debit card, or a digital wallet, is read by a merchant terminal (typically a point-of-sale (POS) terminal). The details read from the payment vehicle can be used to identify an account associated with funds for settlement of the electronic payment transaction. By virtue of the transaction being electronic, real-time data can be obtained on where the transaction is taking place and who has made the transaction (i.e., the cardholder or digital wallet holder).

When making a transaction the merchant typically submits a request to an acquirer (a financial institution with whom the merchant holds an account for facilitating electronic transactions). The acquirer sends the request to an issuer (a financial institution, bank, credit union or company that issues, to cardholders, credit and debit cards, including any that may be contained in the digital wallet) to authorize the transaction. A payment scheme (e.g., MasterCard®) acts as an intermediary between the acquirer and the issuer, or may be the same party as the issuer.

The issuer checks whether there are sufficient funds associated with the payment vehicle and, if so, authorizes the transaction and otherwise declines the transaction. Upon authorization, the merchant releases the product(s) to the purchaser.

During processing of the transaction, electronic payment data 202 is generated and captured. The electronic payment data 202 may also be uploaded to a data warehouse for future use. Thus the electronic payment data 202 can, in a first instance, be used to facilitate determination of real-time demand for vehicles for hire and, in a second instance, be stored in a data warehouse for use as a basis for historical data analysis. In this sense, “real-time” includes “near real-time” insofar as transactions made shortly before a determination of demand for vehicles for hire is made are considered to facilitate real-time determination of that demand. This real-time determination may gather transaction data that occurs within a predetermined period (e.g. 1 minute, 5 minutes, 10 minutes, or 20 minutes) before the determination is made, and all transactions occurring within the relevant period are considered to contribute to “real-time” determination of that demand.

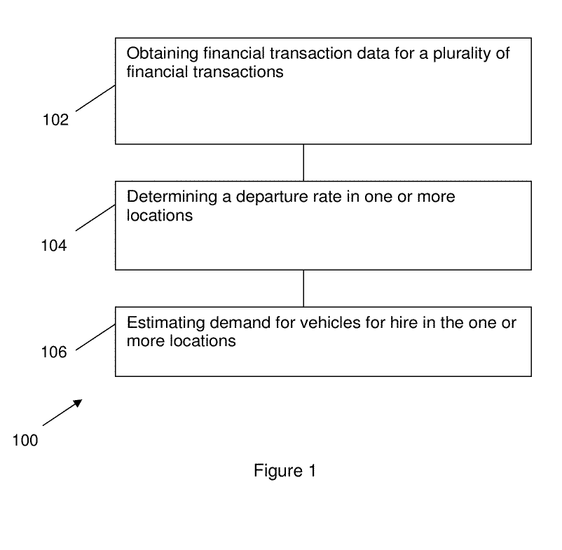

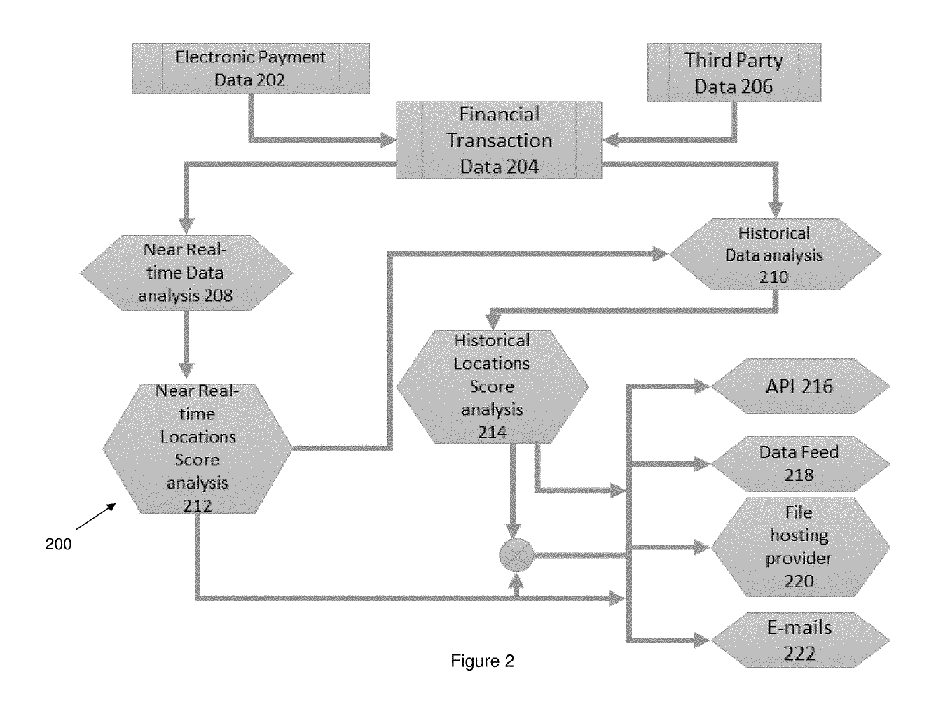

FIG. 1 shows a flow chart 100 illustrating a computer-implemented method for predicting a demand for vehicles for hire in one or more locations, according to an example embodiment. Similarly, FIG. 2 shows a more detailed workflow 200 illustrating a computer-implemented method for predicting a demand for vehicles for hire in one or more locations, according to an example embodiment. The method illustrated by the FIGS. 1 and 2 broadly comprises:
Step 102: financial transaction data for a plurality of financial transactions being obtained from one or more merchants. The financial transaction data comprises location information for each financial transaction and is received (or requested) by a processor or server.
Step 104: determining, based on a number of the financial transactions occurring over a predefined period, a departure rate in the one or more locations.
Step 106: estimating, based on the departure rate, the demand for vehicles for hire in the one or more locations.

The demand may be used, e.g. by transportation companies, to assign vehicles for hire to the one or more locations.

The electronic payment data 202 comprises sufficient data for the electronic transaction to take place. In general, this will be sufficient information to identify the account from which funds are to be debited, along with the merchant to whom the funds should be credited. In practice, electronic payment data 202 can include all, any subset of, and other information in addition to, the following types of data generated/captured when an electronic payment transaction is processed:

Transaction information:
Transaction ID, e.g., a receipt number or reference by which the transaction can be identified
Account ID to identify the card or digital wallet account, such as the credit or debit card number, or digital wallet number
Merchant ID to identify the particular merchant—note: where the merchant is a chain or franchise, each merchant may have a separate merchant ID or a merchant ID may be common to multiple merchants (e.g., outlets). This may also be a merchant code (i.e., unique store code, business registration number, account number with a particular acquirer etc.)
Transaction Amount or value of the item(s) being purchased
Date of Transaction
Time of Transaction
Date of Processing—in other words the date of settlement with the merchant, which may differ from the date of transaction

Account Information:
Account ID
Card Issuer Country being the country in which a credit or debit card was issued, noting that a digital wallet can contain cards from a variety of countries
Card Issuer ID being an identifier by which the issuer of the card can be identified—this is usually incorporated into the card number (i.e., Account ID of the card)
Card Issuer Name

Merchant Information:
Merchant ID
Merchant Name
Factual Merchant Data (store type, type of cuisine served, etc.)
Merchant Country
Merchant Address
Merchant Postal Code
Aggregate Merchant ID which, in the present case, may comprise a merchant ID common to a plurality of associated merchants, such as those in a franchise or chain, or an ID (identifier) associated with a shopping mall or complex in which multiple merchants are located.
Aggregate Merchant Name
Merchant Acquirer Country being the country in which the acquirer holds the merchants account
Merchant Acquirer ID being an identifier by which the relevant acquirer can be identified

Issuer Information:
Issuer ID
Issuer Name
Issuer Country

A server or processor is configured to obtain financial transaction data 204 for a plurality of financial transactions from one or more merchants. The financial transaction data 204 includes the electronic payment data 202 generated when making the transaction. The financial transaction data 204 may also include additional, third party data 206.

The financial transaction data 204 includes location information. The “location information” may refer to the details of the place where a financial transaction has taken place. Examples of location information include, but are not limited to, merchant address, merchant postal code or merchant geographical coordinates. The location information may also comprise a shopping centre where the merchant is one of a plurality of merchants collocated at a common address.

The location information may also comprise a proxy for the actual location of the transaction. For example, the location information may comprise merchant identification information (i.e., a merchant ID). The merchant ID may refer to a unique identifier of a particular merchant or of the shopping centre at which the merchant is located. Based on the merchant ID, the location of the merchant can be obtained from a merchant database where the merchant ID is being stored with the location information, such that the former can be used to obtain the latter.

The financial transaction data 204 may be obtained at the same time as authorization of the electronic payment transaction. In other words, the financial transaction data 204 obtained may include electronic payment transaction data of transactions occurring in real-time. Thus, the real-time demand for vehicles for hire can be predicted using the financial transaction data 204.

Alternatively, the electronic payment data 202 may be uploaded to a database or data warehouse, from which it can be extracted when compiling the financial transaction data 204. Thus, while the electronic payment data 202 can be used for real-time determination of demand for vehicles for hire, older electronic payment data (e.g., that produced before the predetermined period over which the real-time analysis is made) can be used to supplement electronic payment data 202 occurring in the predetermined period. Thus the financial transaction data 204 may include historical electronic payment transaction data. Historical data can be augmented with electronic payment data 202 to improve the accuracy of the determination of demand for vehicles for hire. For example, electronic payment data 202 may comprise, or be associated with, particular real-world data such as the time of day, the particular day of the week or public holiday, the prevailing weather (e.g., it may be that more taxis are hired during rainy periods than during dry periods) etc., and historical payment data comprising or associated with comparable real-world data may be used to supplement the electronic payment data 202. Based on this comparison, the financial transaction data 204 used to determine the departure rate at a certain time and location may comprise the electronic payment data 202 and third party data 206 which comprises historical electronic payment transaction data.

The third party data 206 (or “external data set”) may be obtained from one or more external databases or information service providers. The external data set may include information with respect to real-time events occurring in the one or more locations, or at other locations where those events may affect the demand in the one or more locations in question. Examples of an external data set include, but are not limited to:
weather information, such as whether it is raining or sunny, there is a particularly strong prevailing wind, etc.
sporting event information indicating when a sporting event will end and thus when demand is likely to spike
population density information
airline flight data indicating when flights will arrive and thus when demand will spike at an airport

Real-time event information may advantageously enhance the accuracy of departure rate that might otherwise be determined only taking into account the electronic payment data 202. This is because some customers may leave a merchant's premises without making any electronic payments. For example, a customer may leave a stadium after a football match without making a purchase or leaving a merchant's premises after making cash payments. Thus, by including the external data set, the departure rate may be determined more accurately.

Further, customer identification information, e.g., an account ID, may be obtained for each financial transaction data 204 to identify the respective customer for the financial transaction. The customer identification information obtained can be used to find historical financial transaction data relating to the particular customer. That historical financial transaction data may be stored in the data warehouse as described above or in a separate database, e.g., a customer database.

The customer identification information may be used to query the historical data for that customer to identify transactions relating to previous transportation activity of the customer. Those transactions can be used to infer whether the customer is or is not likely to hire a vehicle after having made a transaction with a merchant in a particular location. In other words, based on the historical financial transaction data, the preference in transportation activity of the respective customer can be determined. For a first customer the historical financial transaction data may show regular spending for a certain type of vehicle for hire, e.g., taxi, indicating a higher preference or likelihood of hiring a taxi than the historical financial transaction data for a second customer which shows that the second customer does not spend on taxi hire. It will be appreciated by a person skilled in the art that the customer identification information may be anonymized such that the identity of the customer is not disclosed to the user of the information.

The preference determined in transportation activity for one or more of the customers can be used to assign weights to the one or more financial transactions. The weight parameters may be calculated using a computer or manually set based on experience. Using the example described above, a weight assigned to a financial transaction made by the first customer who regularly spends on hiring a vehicle is higher than a weight assigned to a financial transaction made by the second customer who does not spend on taxi hire. The departure rate is then determined based on the one or more weighted financial transactions.

A financial transaction assigned a lower weight will be less relevant and have a lesser influence on the determination of demand. As such, a high number of transactions made by people who are unlikely to hire a vehicle (e.g., transactions made at a car club event, where attendees most likely drive to the event) may result in a lower determined departure rate than a lower number of transactions made by people who often hire vehicles. Alternatively, or in combination, a financial transaction data relating to a particular customer may only be taken into account for determining the departure rate if the weight or weights assigned to the financial transactions for that customer exceed a predetermined threshold. Thus, the weight or weights applied to the financial transactions may improve the relevance of the financial transaction data used when determining the departure rate. This, in turn, improves the accuracy of the predicted demand.

Next, the financial transaction data 204 is used for near real-time data analysis 208, and may also be used for historical data analysis 210 depending on the type of financial transaction data 204 obtained by the server or processor. For example, a raw number of transactions at the one or more locations over the predetermined period may not facilitate use of historical data whereas the time of day, customer type etc., may be used to identify historical data from which the server can draw inferences about the financial transaction data gathered over the predetermined period, for example, to apply weights to emphasise or deemphasise certain transactions. Based on a number of financial transactions occurring over a predefined time, and weights and historical data (where applicable), the departure rate at a location may be determined per step 104. The “departure rate” refers to the rate of potential customers leaving a merchant's premises. To determine the departure rate in a location, the financial transactions occurring over the predefined time in the location is aggregated.

Typically, customers would leave a merchant's premises after making payment, i.e., after occurrence of a financial transaction. Assuming there is no weight assigned to the financial transactions, the departure rate determined in a location normally increases with the number of financial transactions occurring in the location. For example, the departure rate in an area may be taken to be the number of financial transactions that occur in the past 1 minute. Where weights are applied, some of the financial transactions may be less relevant to, or may not be used in, determining the departure rate. Thus the departure rate may be adjusted depending on the weights.

The demand for vehicles for hire is estimated in the one or more locations based on the departure rate, at step 106. The “demand” refers to the predicted or forecast rate or number of customers likely to hire vehicles in the location, or one of a plurality of locations, in the near future. The demand for vehicles for hire normally increases with the departure rate. For example, a first location which has a higher departure rate than a second location will usually have a higher demand for vehicles for hire.

In another embodiment, the estimated demand may be dependent on various other factors, such as the location. The estimated demand may be different for two locations having the same departure rate. For example, the estimated demand may be lower for a location nearby convenient alternative modes of transport (e.g., a train station where the customers may conveniently take the train), when compared with another location where no such modes of transport are readily available.

The estimated demand may be stored in a database for future use or may be transmitted as an output. Moreover, the estimated demand may be compared with transactions relating to vehicles hired from the one or more locations, in order to adjust the demand estimated for a previous predetermined period to refine the historical data to make it more accurate when re-used to determine demand for future predetermined periods.

Once the demand has been estimated for the one or more locations, it can be distributed to interested parties, e.g. taxi companies or drivers. For example, the output may be distributed or accessed via application programming interface (API) 216, data feed 218, file hosting provider 220, emails 222 over a website or through a mobile application.

The demand estimated for each location may be represented in different forms. For example, the demand for each location may be categorised into the categories of high, medium or low. In a further embodiment, a list of locations at which demand is high, or otherwise exceeds a predetermined threshold, may be generated according to the estimated demand for each of a number of locations including those on the list. In another embodiment, the demand in each location may simply be represented by a number for each respective location. It will be appreciated by a person skilled in the art that the demand may be represented in other forms and these are only some of the examples.

The output for a location may include a location score for the location. The “location score” may indicate the density of potential customers at the respective location. For example, a number of transactions occurring at merchants located along the same, short street may infer a higher density of potential customers, and result in a proportionally higher location score, than the density and score for the same number of transactions occurring at merchants located along a very long street.

The location score for the one or more locations may be calculated based on the estimated demand and a characteristic of the respective location (e.g., length of the street) in near real-time locations score analysis 212. The location score may also be calculated using both near real-time location score analysis 212 and historical location score analysis 214. In this case, the location score calculated using near real-time locations score analysis 212 and historical locations score analysis 214 may be aggregated and outputted as a single location score.

The “characteristic of the respective location” may refer to the landscape or topography of the respective location, e.g., length of the road and area of the location.

The calculation of the location score takes into account the characteristics of the respective location. This may prevent errors in predicting the demands for two locations with similar departure rates, but vastly different characteristics. Following the previous example, if the departure rates for two locations are similar but one of the two locations has a much larger area than the other, the first mentioned location may have a lower location score for vehicles for hire than the second location. The location score for each location may be represented in the same form as the demand or in other forms.

The output for a location may include a heat map. The location scores for two or more locations may be used to create the heat map for showing the location scores of these locations. Different colours or shades may be used to display the location scores on the heat map. The heat map may advantageously provide a graphical representation to illustrate the estimated demand.

As described above, a demand for vehicles for hire can be predicted using financial transaction data 204 from merchants. Since the financial transaction data 204 includes location information of the transactions, the frequency of transactions over a predefined period and at a particular location may be indicative of the immediate demand for vehicles for hire in that particular location. Transportation companies (e.g., taxi operators) can use this information to assign vehicles to the one or more locations according to the estimated demand. Drivers may also use this information to identify where potential passengers are likely to be. This may enable drivers to work a larger number of jobs over a single shift and may similarly reduce customer waiting times for vehicles for hire in some locations.

FIG. 3 depicts an exemplary computing device 300, hereinafter interchangeably referred to as a computer system 300, where one or more such computing devices 300 may be used in predicting a demand for vehicles for hire. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network. The software routines, or computer programs, may be stored in memory and be executable by the processor to cause the computer system 300 to: (A) obtain financial transaction data for a plurality of financial transactions from one or more merchants, the financial transaction data comprising location information for each financial transaction, the location information corresponding to the one or more locations; (B) determine a departure rate in the one or more locations based on a number of the financial transactions occurring over a predefined period; and (C) estimate the demand for vehicles for hire in the one or more locations based on the departure rate. The software routines or computer programs may also comprise steps executable by the processor to cause the computer system 300 to perform the various other analytical steps (e.g., obtaining third party data or the at least one external data set, and determining and applying weights to financial transaction data).

The computing device 300 further includes a main memory 308, such as a random access memory (RAM), and a secondary memory 310. The secondary memory 310 may include, for example, a hard disk drive 312 and/or a removable storage drive 314, which may include a floppy disk drive, a magnetic tape drive, an optical disk drive, or the like. The removable storage drive 314 reads from and/or writes to a removable storage medium 344 in a well-known manner. The removable storage medium 344 may include a floppy disk, magnetic tape, optical disk, or the like, which is read by and written to by removable storage drive 314. As will be appreciated by persons skilled in the relevant art(s), the removable storage medium 344 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322. Examples of a removable storage unit 322 include a program cartridge and cartridge interface (such as that found in video game console devices), a removable memory chip (such as an EPROM or PROM) and associated socket, and other removable storage units 322 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments, the communication interface 324 permits data to be transferred between the computing device 300 and a data communication network, such as a public data or private data communication network. The communication interface 324 may be used to exchange data between different computing devices 300, which such computing devices 300 form part of an interconnected computer network. Examples of a communication interface 324 can include a modem, a network interface (such as an Ethernet card), a communication port, an antenna with associated circuitry, and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface 324 via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 344, removable storage unit 322, a hard disk installed in hard disk drive 312, or a carrier wave carrying software over communication path 326 (wireless link or cable) to communication interface 324. Computer readable storage media refers to any non-transitory tangible storage medium that provides recorded instructions and/or data to the computing device 300 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card, such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets, including e-mail transmissions and information recorded on Websites, and the like. The computer program product may thus comprise memory in which is stored instructions executable by the processor to cause the computer system 300 to: (A) obtain financial transaction data for a plurality of financial transactions from one or more merchants, the financial transaction data comprising location information for each financial transaction, the location information corresponding to the one or more locations; (B) determine a departure rate in the one or more locations based on a number of the financial transactions occurring over a predefined period; and (C) estimate the demand for vehicles for hire in the one or more locations based on the departure rate. The computer program product may also comprise steps which, when executed by the processor, cause the computer system 300 to perform the various other analytical steps (e.g., obtaining third party data or the at least one external data set, and determining and applying weights to financial transaction data).

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the hard disk drive 312, or the interface 340. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

It will be appreciated that the elements illustrated in FIG. 3 function to provide means for performing the various functions and operations of the servers as described in the above embodiments.

In an implementation, a server may be generally described as a physical device comprising at least one processor and at least one memory including computer program code. The at least one memory and the computer program code are configured to, with the at least one processor, cause the physical device to perform the requisite operations.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for predicting a demand for vehicles for hire in one or more locations, the method comprising:
obtaining, by a server, financial transaction data for a plurality of financial transactions from one or more merchants, the financial transaction data comprising location information for each financial transaction, the location information corresponding to the one or more locations;
determining, by the server, a departure rate in the one or more locations based on a number of the financial transactions occurring over a predefined period; and
estimating, by the server, the demand for vehicles for hire in the one or more locations based on the departure rate.

2. The method as claimed in claim 1, wherein obtaining financial transaction data comprises:
obtaining, by the server, merchant identification information for each financial transaction to identify the respective merchant, of the one or more merchants, for the respective financial transaction; and
obtaining, from a merchant database, the location information of the respective financial transaction based on the merchant identification information.

3. The method as claimed in claim 2, wherein the merchant identification information comprises at least one of a merchant name and a merchant code.

4. The method as claimed in claim 1, wherein obtaining financial transaction data comprises:
obtaining, by the server, customer identification information for each financial transaction to identify the respective customer for the financial transaction;
obtaining, from a customer database and based on the customer identification information, historical financial transaction data for historical financial transactions made by the respective customer in transportation activity; and
determining, by the server, preference in transportation activity of the respective customer based on the historical financial transaction data for historical financial transactions in transportation activity.

5. The method as claimed in claim 4, further comprising analyzing the financial transaction data; and
wherein analyzing the financial transaction data comprises:
assigning a weight to one or more financial transactions based on the determined preference in transportation activity of the respective customer; and
determining the departure rate in the one or more locations based on the one or more weighted financial transactions.

6. The method as claimed in claim 4, wherein the financial transaction data further comprises at least one external data set, the external data set being stored in one or more external database.

7. The method as claimed in claim 6, wherein the at least one external data set comprises information with respect to real-time events occurring in the one or more locations.

8. The method as claimed in claim 7, wherein the information comprises at least one of weather information, sporting event information, transaction density information and airline flight data.

9. The method as claimed in claim 1, further comprising calculating a location score for the one or more locations based on the estimated demand and a characteristic of the respective location, the location scoring being indicative of a potential passenger density at the respective location.

10. The method as claimed in claim 9, wherein the location score is calculated for two or more locations, the method further comprising creating a heat map showing the location scores for the two or more locations.

11. The method as claimed in claim 1, further comprising assigning, by the server, vehicles for hire to the one or more locations based on the demand.

12. A computer system for predicting a demand for vehicles for hire in one or more locations, the computer system comprising:
a memory device for storing data;
a display; and
a processor coupled to the memory device and configured to:
obtain financial transaction data for a plurality of financial transactions from one or more merchants, the financial transaction data comprising location information for each financial transaction;
determine a departure rate in the one or more locations based on a number of the financial transactions occurring over a predefined period; and
estimate the demand for vehicles for hire in the one or more locations based on the departure rate.

13. A computer program embodied on a non-transitory computer readable storage medium for predicting a demand for vehicles for hire in one or more locations, the program comprising at least one code segment executable by a computer to instruct the computer to:
obtain financial transaction data for a plurality of financial transactions from one or more merchants, the financial transaction data comprising location information for each financial transaction;
determine a departure rate in the one or more locations based on a number of the financial transactions occurring over a predefined period; and
estimate the demand for vehicles for hire in the one or more locations based on the departure rate.
